(19) United States
(12) Patent Application Publication
(10) Pub. No.: US 2007/0133969 A1
(43) Pub. Date: Jun. 14, 2007

(54) System and method for measuring and setting the focus of a camera assembly

(75) Inventors: Carmel Ish-Shalom, Alameda, CA (US); Pimai Seelao, Fremont, CA (US)

Correspondence Address: STEVENS LAW GROUP, P.O. BOX 1667, SAN JOSE, CA, 95109, US

(73) Assignee: ESS Technology, Inc., Fremont, CA (US)

(21) Appl. No.: 11/479,409

(22) Filed: Jun. 30, 2006

Related U.S. Application Data
(60) Provisional application No. 60/749,867, filed on Dec. 12, 2005.

(51) Int. Cl. G03B 13/32

(52) U.S. Cl. 396/89

(57) ABSTRACT

A system and method are provided for automatically setting the focus of a camera assembly; providing a camera assembly having a sensor die having indicia points located on a surface, a lens assembly having at least one optical lens; a lens assembly holder configured to adjustably hold the lens assembly in a position about the sensor die, and; exposing the lens assembly to a light source; automatically adjusting the lens assembly with respect to the sensor die; automatically measuring the focus of each focal indicia with respect to the positions of the lens assembly; and setting the position of the lens assembly with respect to the sensor die at an optimal position.

### BACKGROUND

Techniques for the manufacture and testing of miniature camera assemblies are well known in the art, and many methods exist to build and test such assemblies for quality assurance. However, now that camera components are becoming smaller, and as demand for higher quality continues to increase, conventional testing techniques are becoming obsolete. In particular, the manner in which to measure accurately the focus parameters and set the focus of a camera assembly in development and manufacturing is very difficult, and cannot be adequately done given conventional techniques. Also, as devices get smaller and as consumer demand requires increased quality and resolution, the sensor dice get thinner, and lenses are also getting reduced in size. With better quality cameras coming in demand, the manufacturing environment requires more accurate testing and measuring.

Also, conventional methods of focusing a lens with respect to a die chip are not adequate for consistent quality and accuracy. Current methods include manually adjusting the camera lens holder and visually adjusting the focus. As cameras become smaller, such as cameras used in cellular telephones, and as higher resolution is demanded, better focusing techniques will be required.

Therefore, there exists a need in the art to accurately measure and set the focus of a camera assembly for consistent quality and accuracy. As will be seen, the invention accomplishes this in an elegant manner.

### THE FIGURES

FIG. 1 is an expanded view of a camera assembly according to the invention;

FIG. 2 is an assembled view of the camera assembly according to FIG. 1;

FIG. 3 is another view of the camera assembly of FIG. 1 in relation to a substrate;

FIG. 4 is another illustration of a camera assembly of FIG. 1;

FIG. 5 is a view of the sensor surface with indicia;

FIG. 6 is a view of a layout according to the invention;

FIG. 7 is a flowchart according to the invention;

FIGS. 8a, 8b and 9 are graphs of MTF values;

FIG. 10a,b is a flow chart of a method according to the invention is a view of a sensor die according to the invention;

FIG. 11 is a diagrammatic view of a filter;

FIGS. 12-14 are a diagrammatic views of a system according to the invention; and

FIG. 15 is a view of a robot and holding system according to the invention.

### DETAILED DESCRIPTION

The invention is directed to a system and method for testing a camera assembly. In particular, the invention is directed to a system and method for measuring, adjusting, setting the focus and performing quality control and assurance of completed camera assemblies. In this description, references to “the invention” are intended in the most general sense, and the embodiments described herein are merely examples of embodiments of the invention, and are not intended to be limiting the scope of the invention, which is defined by the appended claims. Also, throughout this description, it is assumed that the lens or lens assembly pertains to any type of camera lens used in connection with a sensor die, and the lens or lens assembly may contain one or more lenses. A camera assembly is provided having a sensor die, where the die has a plurality focal indicia located on a surface. The indicia are locations where measurements are taken, and may be one or more pixels at a predetermined location, or may be other indicia configured for the same purpose. When the camera assembly is constructed, a lens assembly holder is positioned in the proximity of the sensor die, and a lens assembly having one or more optical lenses is adjustably held within the lens assembly holder and having a focal axis. After the camera assembly is assembled, the camera assembly can be positioned about a measuring device and exposed to a light source. The focus of each focal indicia located on the surface of the sensor die is then measured with respect to the position of the lens assembly. Throughout the measuring of the focal indicia, the position of the lens or lens assembly is adjusted. Focus measurement data can then be retrieved and recorded, and with the measurement data, the setting of the focus of the camera assembly can be done, and quality control and assurance can be performed as well.

In this method the completed camera assembly is tested for precise optimal focus position in the center and corners of the sensor die. The method requires precise positioning and movement of the lens assembly while measuring the position and the focus at the measurement locations. Focus on each indicia is measured by means of a Modulation Transfer Function (MTF). This gives a numerical MTF value that represents the quality of focus on a particular point. Once the data is collected, optimal focus values and positions are extracted for each measurement position and the optimum position for the lens assembly can be easily determined.

Again, prior conventional measurement methods have inherent difficulties in precision of the mechanical measurement. With this novel system and method, mechanical adjustment of the lens assembly can be performed, the focus of the camera assembly can be set, and quality assurance and control can be done to ensure the optimum quality of the assemblies. And, the system and method can be added to production testing to improve the quality of the end product, the camera.

The Modulation Transfer Function (MTF) is a fundamental imaging system design specification and system quality metric often used in remote sensing. The invention uses this quality metric in centering in on the relevant indicia on the sensor surface. In one embodiment, five pairs of predetermined areas of pixels make up the indicia of interest on the surface of the sensor chip. Five locations are used to determine the focus parameters. In one embodiment, indicia are in a predetermined location on the sensor chip and known by the measuring device. These may be an area of pixels in the different locations for example. Once the MTF values are measured, the location of the indicia can be determined by the high MTF values about a maximum point. Thus, the location can be determined according to a threshold that indicates a substantially close approximation of the location of the points, the indicia of interest. Once the location of various points or indicia are determined, their MTF can be measured and optimum focus settings can be calculated. The measurement device knows the distance that the indicia should be, within a range, where the focus values are within an acceptable tolerance. If the focus value is not within that tolerance, then focus is not acceptable, and the camera assembly is thus outside the quality standard. In contrast, if the focus is within the tolerance thresholds, then the camera assembly is within the quality standard, and the camera has an adequate focus setting.

Many methods of measuring MTF are well known by those skilled in the art. MTF may be defined as the normalized magnitude of the Fourier Transform of the imaging system's point spread function. Alternatively, the MTF may describe the attenuation of sinusoidal waveforms as a function of spatial frequency. Practically, MTF is a metric quantifying the sharpness of the reconstructed image based on light rays captured by a light sensor over an area range. MTF measurement techniques are well known for quantifying the along scan and cross scan MU profiles. Many measurement techniques exist that are designed to provide accurate measurements for high resolution imaging systems. Additionally, a confidence interval is assigned to the measurement as a statement of the quality of the measured value. The classical slant-edge measurement technique for discrete sampled systems may be employed. Fixed high-contrast targets are used to obtain MTF measurements in the center of the array. As access to such targets is limited, suitable edges for analysis are identified in nominal operational imagery. The measurement results from the specialized targets are used to confirm the large number of measurements from the operational imagery.

Multiple methods have been proposed for determining the MTF of remote sensing systems. These include imaging lines or points and potentially using imagery from a system with known MTF. In general, these measurement techniques require a particular size and orientation of targets based on the GSD and scan direction of the sensor to achieve good performance. Another approach is to use edges to determine MTF. The edge spread function (ESF) is the system response to a high contrast edge. The derivative of the ESF produces the line spread function (LSF), which is the system response to a high contrast line. The normalized magnitude of the Fourier Transform of the LSF produces a one-dimensional slice through the two-dimensional MTF surface. Other methods exist for computing the system MTF directly from the ESF that remove the need for differentiation. A requirement for determining MTF from edges is to have a high fidelity representation of the ESF. The slanted edge algorithm uses the change in phase of the edge across the sampling grid to create a “super-resolved” ESF.

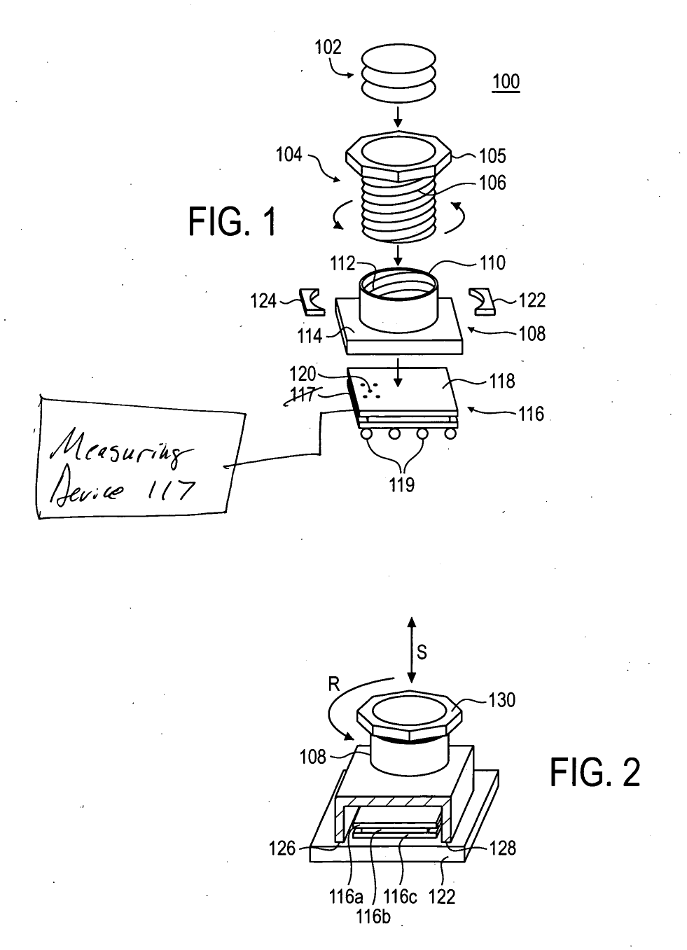

Referring to FIG. 1, an expanded view of a camera assembly to be tested and measured according to the invention is illustrated. Several of the components of the camera assembly are well known to those in the art, however, their use in testing and measuring according to the invention are novel and useful. The invention is directed to a system and method of adjusting and testing such a camera assembly, and this particular assembly illustrated is not meant to be limiting to the invention, but is meant to be illustrative of the application of the invention in testing such a camera assembly. Also, as new types of camera assemblies evolve in the industry, the system and method of the invention can be used to measure the MTF values from the sensor surface of any new type of camera while adjusting the lens assembly. More particularly, the system and method can be used to adjust the focus of the camera assembly, measure the MTF of positions on the sensor surface, set the focus of the camera assembly and perform quality assurance and control in a manufacturing process for camera assemblies.

Still referring to FIG. 1, the camera assembly 100 may include one or a plurality of lenses 102 that are held within the lens assembly 104. The lens assembly may include an octagonal rim 105 and threads 106. In operation, the octagonal rim can be used to engage and adjust the lens assembly within the lens assembly holder 108, in order to adjust the focal length of the lenses. The threads 112 within the lens assembly holder are complimentary to the threads 106 of the lens assembly, thus, the lens assembly can be rotated within the inner threads 112 of the lens assembly holder to adjust the focal length of the lens or lenses within the lens assembly. The lens assembly holder 108 includes inner threads 112 that are located within the lens assembly cavity 110. The lens assembly cavity 110 part of on the lens assembly holder base 114. In the final assembly, this base is mounted on the sensor chip 116. A measuring device 117 is configured to communicate with the sensor chip in order to measure and record different aspects of light rays that travel through the lenses within the lens assembly, through the lens assembly holder and onto the surface 118 of the chip that includes optical indicia locations 120.

The optical indicia locations may be predetermined areas of the sensor chip, such as an area of 40 by 40 pixels for example, that are generally or specifically located in a predetermined location. MTF values are measures at these locations, and the values are used to determine the optimum adjustment and setting of the lens assembly in a camera assembly. Those skilled in the art will understand that there are many configurations and options in choosing areas on which to focus, including whether to focus on horizontal or vertical lines, or between white and black pixels, or other between other aspects of the focal area. Thus, the invention is not limited to any particular type or size of area on which to focus. Described herein and illustrated in the figures are certain embodiments of the invention that embody various features provided by the invention, and, again, the invention is not limited to any of these particular embodiments.

According to the invention, in a testing phase, light travels through the lenses 102 and on through the lens assembly and lens assembly holder and onto the sensor chip surface, where the light rays are measured by the pixels located on the sensor chip. The optical indicia locations 120, which are located on the surface of the sensor chip for measurement purposes. Since this is a camera assembly, it is imperative that the light that travels through the lenses and on to the sensor chip, and that the light is accurately captured and recorded for quality camera operations.

In practice, light reflects off of an image and is captured by the camera lens. The light may be naturally occurring light or may be enhanced by a flash bulb or other light source. Thus, a representation of an image focused on by the camera exists in the reflected light. The lens or lens assembly is configured to capture and focus this light onto a sensor chip. The lens or lens assembly is configured with an optical axis, which is the direction in which the light travels through it. This light is then cast on a sensor chip that has reactive elements, or pixels, that capture the representative light in a two dimensional manner. The pixels then transmit values indicative of the color, contrast and other light information captured by the individual pixels to a processor for storage of the values. A processor then processes the values and is able to reproduce photos of the image. These can be reproduced on an electronic screen, printed on photograph paper or reproduced in other manners. According to the invention, the focus values of the sensor surface can be measured and calculated to determine whether the resulting camera assembly is of adequate quality.

In one embodiment, holders or braces 122, 124 hold the camera assembly in place and different types of light are passed through the lenses in order to test the camera assembly. Many types of holders of camera assemblies can be configured, the simplified holders or braces 122, 124 are intended as examples to illustrate the basic concept of bracing the camera assembly, and those skilled in the art will understand that many well known devices and techniques can be configured to hold a camera assembly while being tested. Such light can be sent through filters or other means by which light or lack thereof can be sensed by the sensor chip and recorded by the measuring device 117. In one embodiment, a combination of an Opal filter and an LED (light emitting diode) array for a light source gives very uniform light distribution across the imager, allowing for the detection of particles in the optical path. Other problems with sensor quality can be detected as they are in the system.

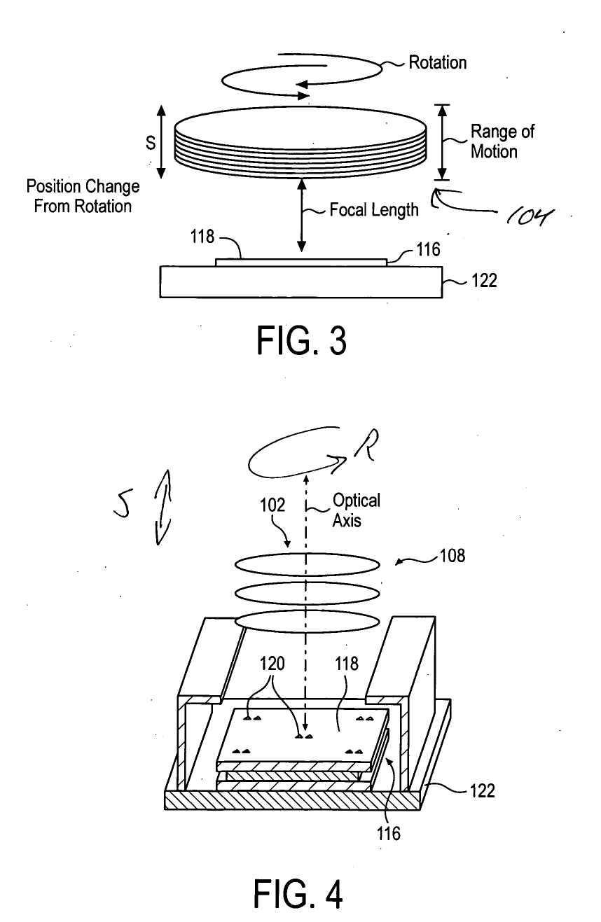

Referring to FIG. 2, an assembled version of the camera assembly of FIG. 1 is illustrated. The die may be one of many configurations, where the sensor 116a is a separate entity, mounted on a spacer 1 16b that separates the sensor from the die 1 16c, which is mounted on substrate 122. There are many different types of die assemblies and configurations, and the invention is not limited to any particular one. In operation, the octagonal rim 130 may be caused to be rotated, thus rotating the lens assembly and the associated lenses, varying the distance of the lenses from the surface of the sensor chip. In operation, the “R” rotating motion causes the lens assembly to move in the perpendicular direction “S” and varies the distance of the lenses with respect to the sensor chip. Such an assembly is common for use in camera phones and other applications. The invention is directed to a system and method of adjusting and measuring MTF values to obtain an optimal focus setting in a camera assembly being tested. Also, the assemblies can be tested for quality assurance and control, where assemblies failing a predetermined focus quality threshold can be discarded or otherwise separated from better quality assemblies.

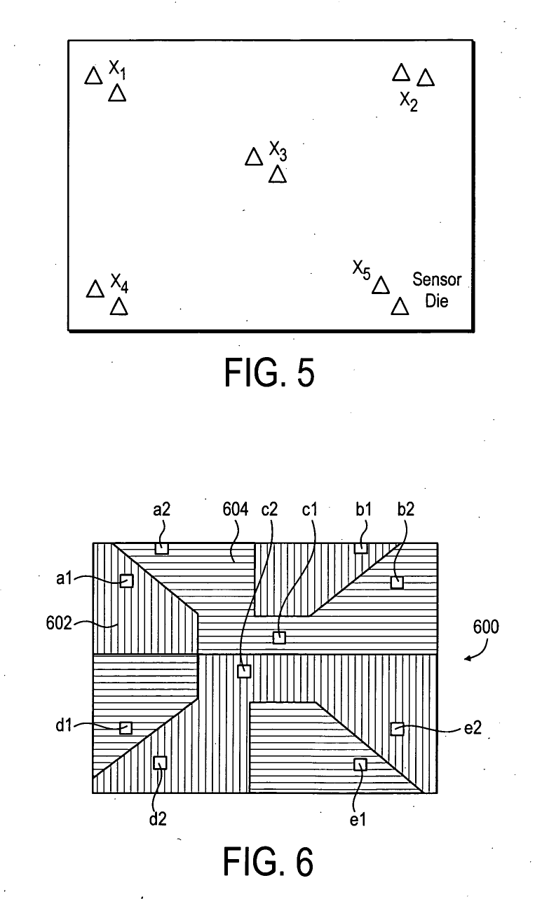

Referring to FIG. 3, a simplified diagram of a camera assembly is illustrated showing the lens holder 104 in relation to the die surface 118 of die 116, shown mounted on substrate 122. The rotation of the lens assembly adjusts the location S, which determines the focus, the distance between the lens assembly and the die surface 118. In operation, the lens assembly has a limited Range of Motion in which to change the location S.

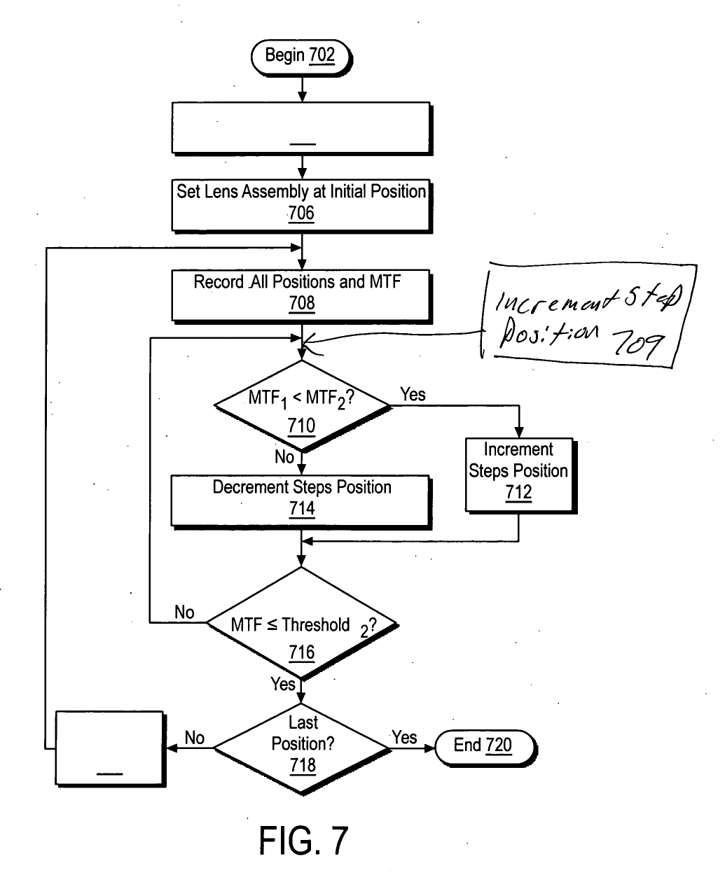

Referring to FIG. 4, a partial cut-away illustration of a camera assembly 107 is shown in relation to the sensor chip 116. The lenses 104 can be rotated in directions “R” in order to move the lenses themselves in a vertical manner “S” with respect to the lens assembly holder 108 in order to vary the focal position. The sensor ship 116 is shown with the optical focus points 120 that are located in predetermined locations on the surface 118 of the sensor die. According to the invention, the optical lens assembly 102 can change the focus position, and can be used to focus in and measure an MTF focus value on the optical indicia locations 120 in order to determine the optimal focus setting of the lenses 102 with respect to the sensor chip. As discussed above, these optical indicia areas may be simply certain pixels or areas of pixels that are predetermined. Once this measurement is determined, the quality of the camera assembly in general can be determined with respect to the focus value.

In operation, depending on the quality of the picture or photograph desired by a given camera assembly, a tolerance of focus measurements can be predetermined. If an optimal focus value for a camera assembly cannot be found, then the camera assembly can be discarded and not moved forward in assembly for the final product. Also, the camera assembly may be used as a statistical sample of a number of camera assemblies for testing quality in a system that produces volumes of camera assemblies. The final products may be a hidden camera spy assembly, a camera used on a cellular phone, or any other type of miniature camera assembly where a certain level of quality is desired. Prior to discovery of this invention, conventional methods included vary crude manual adjustments of the camera assembly. However, with modern camera assemblies reaching higher resolutions, such measurement and setting methods are becoming obsolete. The conventional measurement was acceptable in older conventional systems when cameras were first introduced into cellular telephones. However, consumers are now requiring and manufacturers are now striving to provide higher quality cameras on cellular phones, thus requiring more accurate camera assemblies as those illustrated herein. According to the invention, a testing and measuring method and system are provided for determining the quality of the camera assemblies by measuring the focus of the sensor chip with respect to the optical axis of the lens holder 108.

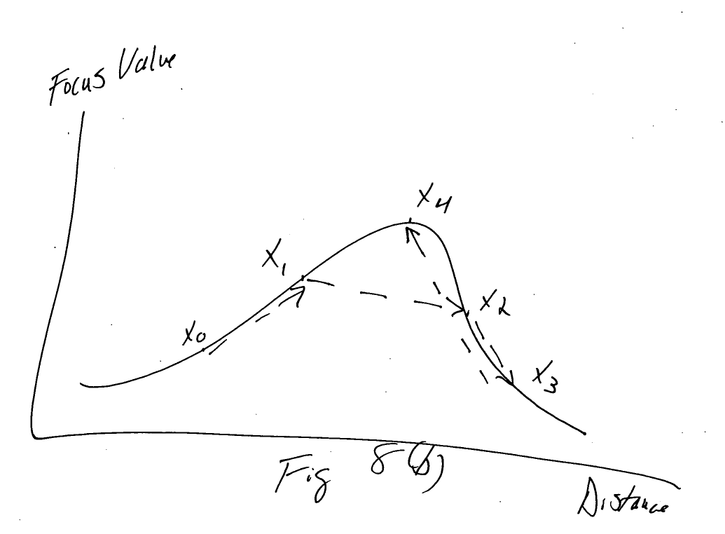

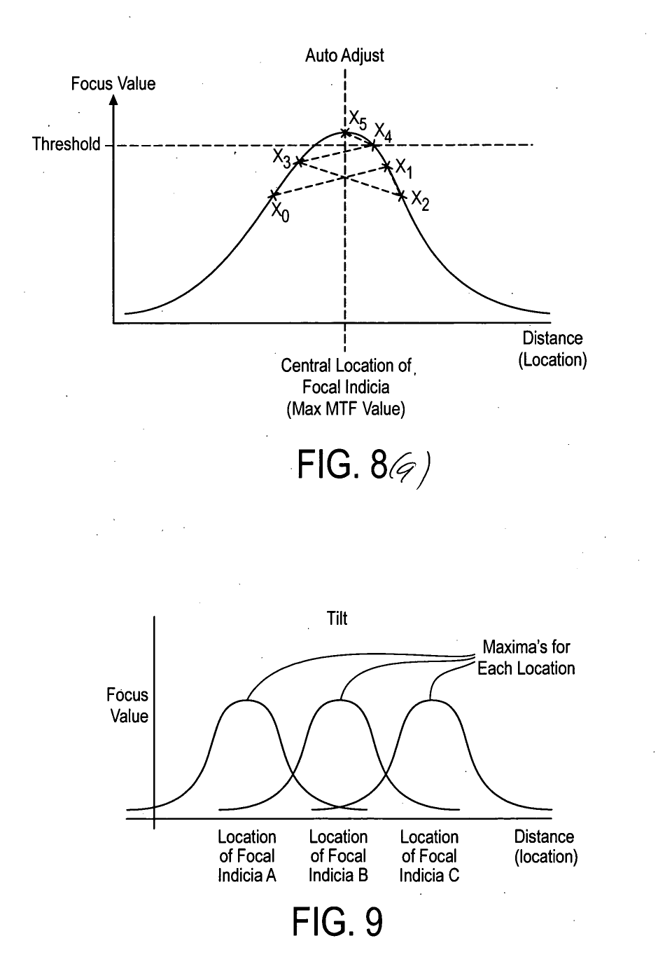

Again, the invention is directed to measurements of the Mm value at locations on the surface. Referring to FIG. 5, the surface of the die 118 is illustrated having optical indicia X₁, X₂, X₃, X₄, and X₅. As can be seen, these indicia are located at different locations on the sensor die surface. Referring to FIG. 6, another embodiment of the invention is illustrated, where the different optical indicia locations (a₁, a₂, b₁, b₂, c₁, c₂, d₁, d₂, e₁, e₂) are located on the horizontal and vertical lines of the target used to measure MTF. In a preferred embodiment, these indicia are predetermined areas on the sensor die. It has been discovered that a more accurate focus measurement of Mm can be obtained when taking into consideration both the vertical and horizontal line measurements on a sensor surface. Layout of 600 of FIG. 6 is a targe surface, where horizontal and vertical lines are illustrated on the layout. This is used by exposing the camera assembly to light reflected off the layout, and readings are taken at the sensor chip. The light is projected from a target with these lines and the MU is measured fo the focus.

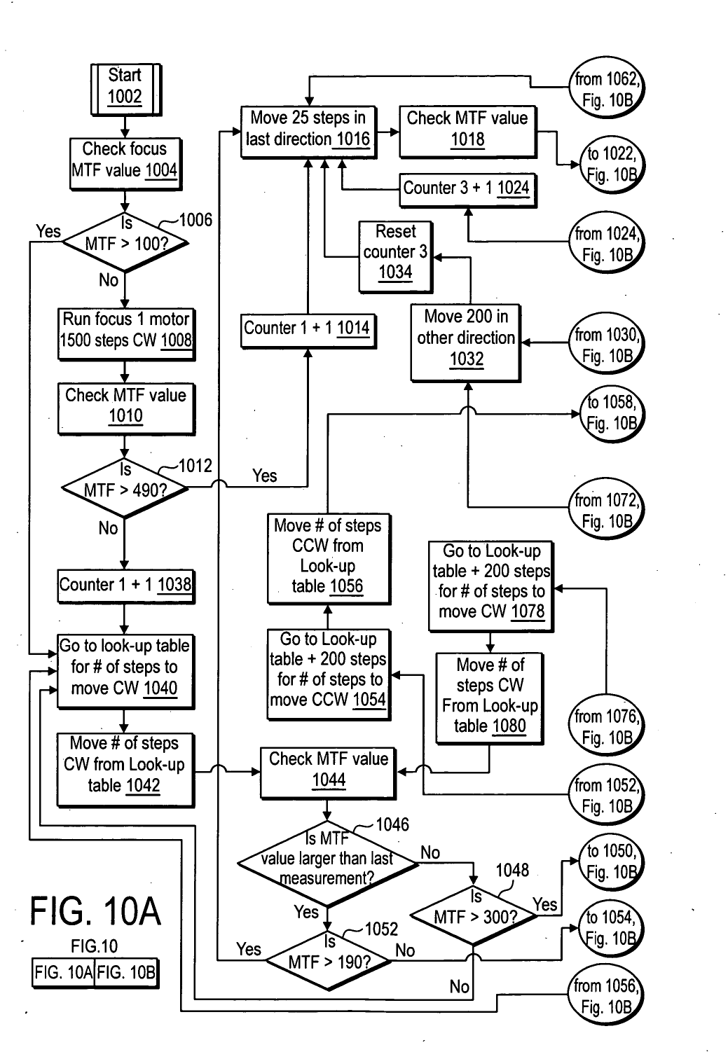

Referring to FIG. 7, a high level embodiment of the invention is illustrated as a flow chart showing the basic steps for adjusting the focus of a camera lens or lens assembly with respect to the surface of a sensor die. The method illustrated by the flow chart is a general high level description of the steps for incrementing and decrementing the adjustment of the lens or lens holder focus position with respect to the sensor die. Initially, in step 706, initial position is set, and and MTF are recorded as they are detected. In the next step, all positions and MTF are recorded. If MTF1 is <MFT2, then the steps are incremented in 712, or, if not, decremented in 714. If MTF is less than or equal to threshold in 716, it ends. If not, it returns to 709, where position is incremented.

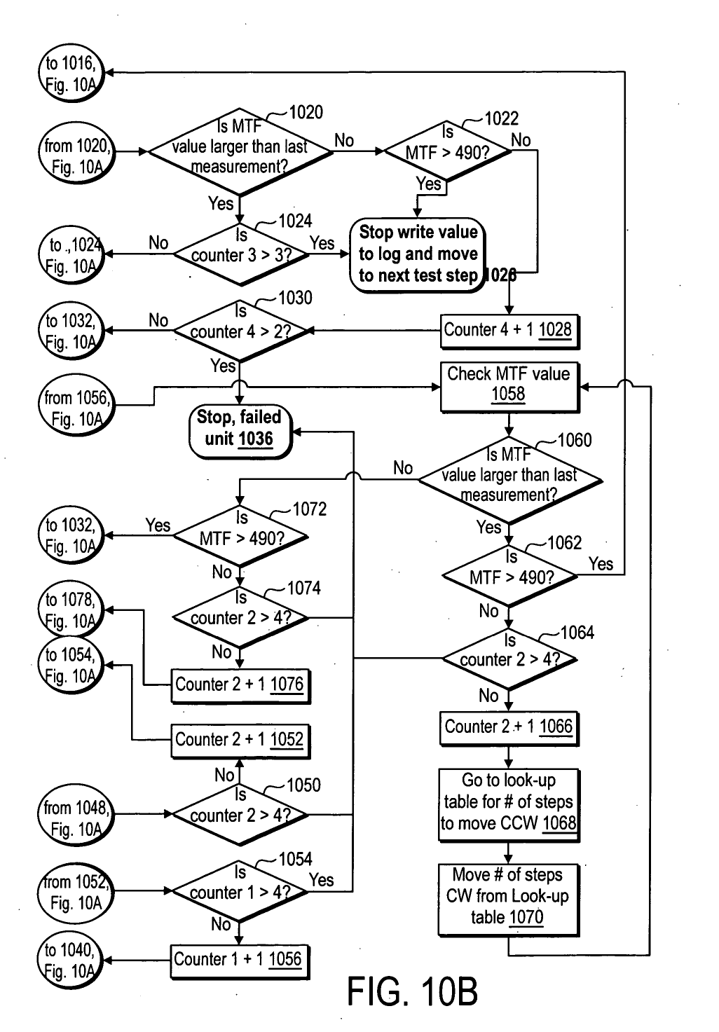

Referring to FIG. 8a, a graph of measuring points as plotted on a graph of the Focus Values versus an optical indicia location on the sensor surface is illustrated. Generally, the measurements start at a starting point, such as X₀ here, and traverses back and forth in a calculated manner through points X₁ through X₅, to reach a maximum point, here X₅. The MTF value at this point is used to determine the optimum focus of the camera assembly. FIG. 8b illustrates an alternative step process.

Referring to FIG. 9, another graph is illustrated, this time with the MTF value curves from different optical indicia locations. As can be seen, the maximum values at each location can be calculated, and they can each be used to determine the optimum focus of the camera assembly being tested. For the auto-adjustment process, and average can be taken of the focus adjustments in order to establish an optimum focus setting for a camera assembly. This can be done by using a weighted average of the measurements taken, or can be done using other intelligent methods. For example, a weighted average can be taken by weighting the center locations measured more than the other locations. Depending on how the sensor surface is designed, it may be more accurate to weigh the measurements taken from the different locations in different ways.

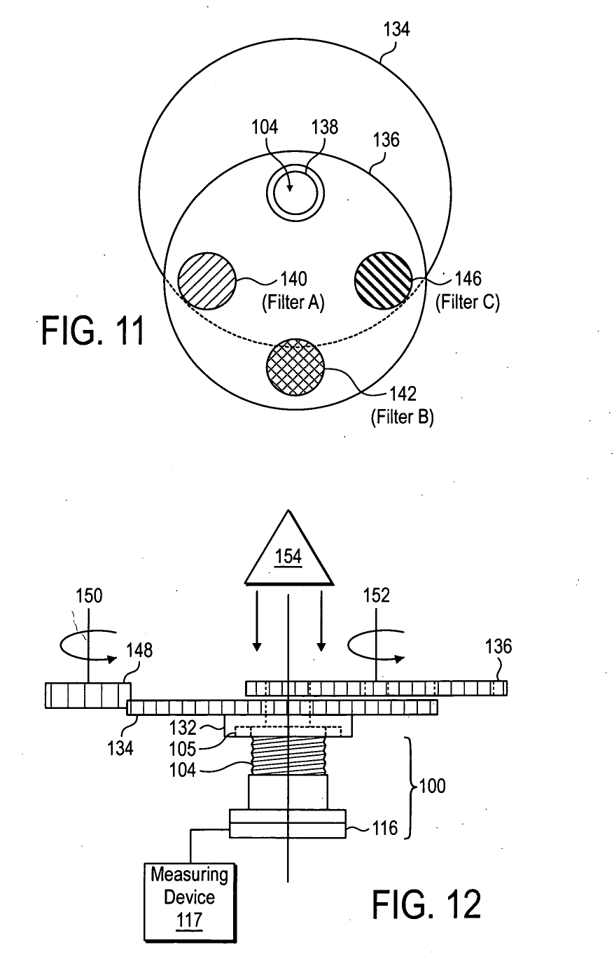

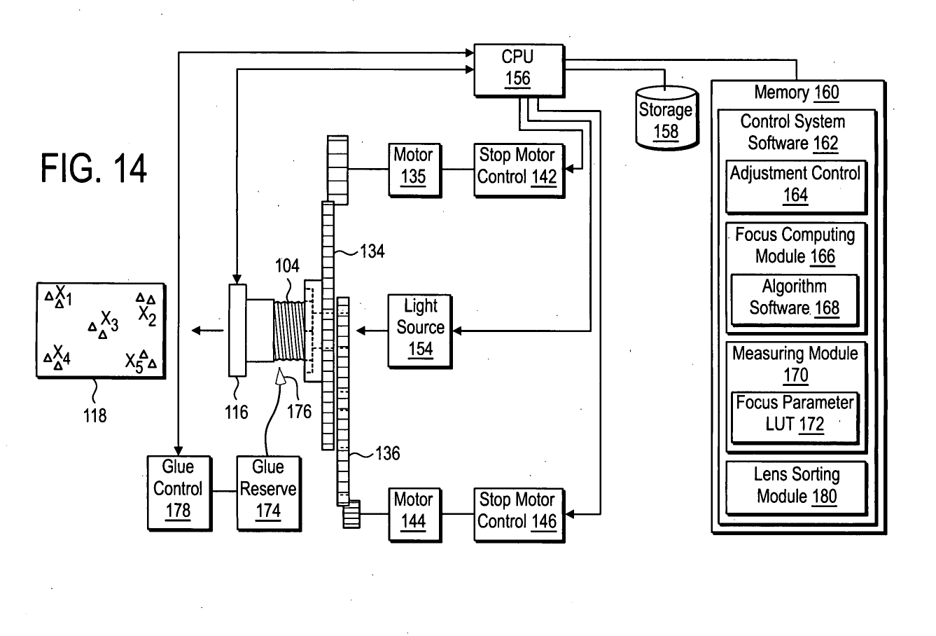

Referring to FIG. 10, a system for testing camera assemblies and adjusting and setting focus is illustrated. The process illustrated herein includes specific tolerances, step orders, MTF values and other specific data and information that is particular to this embodiment of the invention. It is intended, however, and will be understood to those skilled in the art that such granularity does not limit the scope of the invention, but is merely a working example to show an enabling example of a system configured according to the invention. The scope of the invention is defined by the appended and future claims and their equivalents. The process starts and step 1002 where the camera assembly is mounted onto the camera assembly holding apparatus for testing and a filter assembly and related adjustment gear assembly are mounted onto the camera assembly for testing. In this step, and referring ahead to FIG. 12, the camera assembly is locked into the gear assembly via the octagonal rimmed lens assembly 105 by the lens assembly lock 132. Initially, instep 1004, the system checks the focus MTF value. This is done for each focal point 120 located on the sensor surface 118 in order to determine the initial MTF value of each of th 10 measured locations. In step 1006, this determination is made. If the MTF is not greater than 100, then in step 1008 the focus motor is rotated a pre-determined number of steps, such as 1,500 steps clockwise in this example. In step 1010, the MTF value is once again checked. In step 1012, if the MTF is greater than a pre-determined threshold number, such as 490 in this example, then the process proceeds to step 1014 where the first counter is incremented by 1. Again, the example of an MTF value of 490 is an arbitrary number chosen as a starting point. This starting point could vary from application to application, particularly from one type of sensor chip to another. Those skilled in the art will understand that there are many variables accounted for in choosing such starting point values, and even trial and error may be employed. Either way, the invention is not limited to any particular MTF values or other threshold parameters. Or directions or order of steps to adjust the focus.

The process then moves to step 1016 where the step motor moves 25 steps in the last direction that it was moved. In step 1018, the MTF value is again checked. In step 1020, it is determined whether the MTF value is larger than the last measurement taken. If it is not larger than the last measurement taken, then, in step 1022, it is determined whether the MTF is greater than a pre-determined number, 490 in this example. If it is not greater than this predetermined number, then the process stops at step 1026 where the process writes the value into a log, or memory, and moves to the next step. At this point, the next focal position is tested getting back at step 1002. Referring back to step 1022, if it is determined that the MTF is greater than the pre-determined number, 490 in this example, then the process proceeds to step 1028 where counter 4 is incremented by 1. The process then proceeds to step 1030, where it is determined whether a counter 4 is greater than 2. If it is not greater than 2, then in step 1032 the step motor is moved 200 steps in the opposite direction of the last direction. Then, in step 1034, counter 3 is reset and the process in step 1016 is repeated. This process is performed simultaneously on all 10 measuring locations. Referring back to step 1030, if it is determined that the counter 4 is greater than 2, then the process moves to step 1036 where it is determined that the unit has failed. Thus, in this step, the camera assembly has failed and would be pulled from production.

Thus, according to the invention, an ultimate decision can be made that the camera assembly does not have an adequate MTF value for a quality camera. It can then be discarded. The invention provides not only a system and method for setting the focus, it also provides a method of discarding a camera assembly if it does not meet a predetermined MTF specification.

Referring back to step 1012, if it is determined that the MTF is not greater than 490, then counter 1 incremented by 1 in step 1038 and, in step 1040, the process goes to a look up table for a number of steps to move clockwise in order to adjust the lens assembly again. The same process is done, referring back to step 1006, if it is determined that MTF is greater than 100.

After step 1040, the process proceeds to step 1042 where the appropriate adjustment gear is moved a number of steps clockwise as determined from the look up table value. Then, instep 1044, the MTF value is checked again. In step 1046, if the MTF value is not larger than the last measurement, then the process proceeds to step 1048, where it is determined whether the MTF is greater than 300. If it is determined that MTF is greater than 300 in step 1048, then the process proceeds to step 1050 where it is determined whether the counter 2 is greater than 4. If it is not greater than 4, then the process proceeds to step 1052 where counter 2 is incremented by 1 and the process then proceeds to step 1054 where the process goes through a look up table and adds 200 steps to the number of steps taken from the look up table to move the focal adjustment gear counter clockwise. The 200 steps addition is to account for mechanical backlash when a gear system damages direction. The process then proceeds to step 1058 to check the MTF value. Then, in step 1060, is determined if the MMF value is larger than the last measurement taken. As can be seen, the different measurements are checked back and forth in order to narrow into the optimal value that is the optical measurement value of the optical point located on the surface of the sensor chip 116. In step 1060, if the MTh value is larger than the last measurement, then in step 1062, it is determined whether the MTF value is greater than a pre-determined number, 490 in this example. If it is greater than 490, then the process returns to step 1016 where focal adjustment gear is moved 25 steps in the last direction and the process proceeds to step 1018 and continues again to the step 1026 to write the value to the log and move to the next step. If, however, the MTF value is determined to not be greater than 490, then the process proceeds to step 1064 where it is determined whether the counter 2 is greater than 4. If it is not greater than 4, the process proceeds to step 1066 where counter 2 is incremented by 1 and then, in step 1068, the process goes to a look up table for a number of steps to move counter clockwise. In step 1070, the focal adjustment gear is moved a number of steps counter clockwise as determined from the look up table in step 1070. The process then proceeds to step 1058 to once again check the MTF value. This process is again through step 1060 and subsequent steps as above described. In step 1060 if it is determined that the MTF value is not larger than the last measurement, then the process proceeds to step 1072 where it is determined whether the MTF is greater than the pre-determined number, 490 again. If it is determined that the MTF is greater than 490, then the process proceeds to step 1032 and subsequent steps as above described for further testing and measuring. If, however, the MTF is found to not be greater than the pre-determined number, 490, then the process proceeds to step 1074 where it is determined whether counter 2 is greater than 4. If it is greater than 4, then the process proceeds to step 1036 where the process stops, and it is determined that the unit has failed. Here, the camera unit is taken out of production. If, however, counter 2 is not greater than 4, the process proceeds to step 1076 where counter 2 is incremented by 1 and the process then proceeds to step 1078 where the process goes to the look up table and adds 200 steps to the value retrieved and moves the focal adjustment gear clockwise. Then, in step 1080, the process moves the focal adjustment gear the number steps clockwise from the value taken from the look up table, in step 1080. The process then proceeds to step 1044, where the intent value is again checked. The process then proceeds to the other steps.

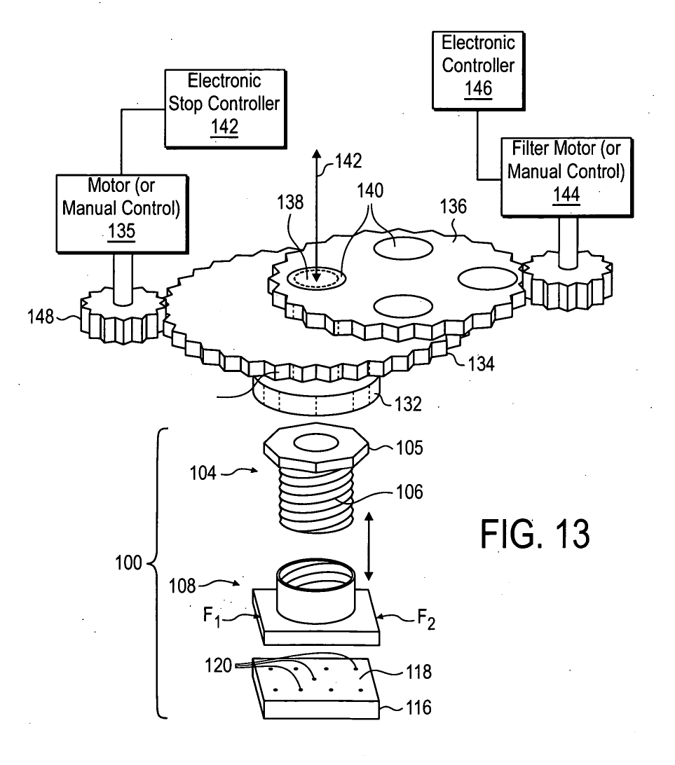

Referring to FIG. 11, the relationship between the focal adjustment gear 134 and the filter gear 136 is illustrated. In this position, the lens assembly 104 is seen through filter gear 136. In this position, the lens assembly is exposed entirely to light by an opening that is unobstructed. The filter gear, however, may include multiple filters 140, 142, 146, which may filter out certain types of light, including a filter such as 146 that entirely excludes all types of light in order to measure possible hot pixels as discussed above. The filter gear may also have an area where there is no filter or opening, where light may be substantially blocked from the camera assembly at that sensor. This area can be used to completely block out light from the camera to detect pixels that appear to be detecting light in the absence of actual light, which are known as hot pixels.

Referring to FIG. 12, an assembled version of the camera assembly connected to the adjustment assembly is illustrated. As can be seen the lens assembly 104 and its octagonal rim are locked into lens assembly lock 132, which is connect to the focal adjustment gear 134. The step down gear 148 connected to the focal adjustment gear 134 may be operated by rotating means 150 in order to adjust the optical axis of the lens assembly 104 with respect to the sensor chip 116. Likewise, the filter gear may be rotated by rotating means 152 in order to change the type of filter that is used in the testing and measuring operation. In the testing and measuring operation, a light source 154 shines a light at a pre-determined frequency through the filter gear and through an opening in the adjustment gear 134 to expose the camera assembly 100 to light. Such exposure can be controlled by different filters such as infrared filters, black out filters, and other filters that filter out certain light frequencies for testing purposes. Measuring device 117 communicates with the sensor chip 116 in order to conduct such measurements. Referring to FIG. 13, a more detailed assembly, a diagrammatic view of a system for testing the focus values for a camera assembly is illustrated.

FIG. 13 is presented as one embodiment of a system and method of performing such measurements. In one embodiment, the sensor chip 116 is connected to the lens assembly holder 108, which is configured to receive the lens assembly 104 via the threads 106. The octagonal rim 105 is configured to be received in the lens assembly lock 132 controlled by gear 134, which has a corresponding octagonal shaped aperture that is configured to fit the octagonal rim 105 within a certain tolerance. In operation, when the assembly turns, the lens assembly lock connected to the lens assembly 104 can rotate the lens assembly with respect to the lens assembly holder. As the lens assembly 104 rotates, the lenses within (not shown) are moved with respect to their focus position, which moves in relation to the surface of the sensor chip having sensor points 120. The light path 142 passes through the gearing mechanisms to the lens assembly 104 to be sensed by sensor chip 116.

Still referring to FIG. 13, a focal adjustment gear 134 is connected with a common central axis of the lens assembly lock 132. This focal adjustment gear may be connected to a motor control 135 in order to adjust the lens assembly 104. A filter gear 136 is configured to cover an opening 137 and to provide various filters of light that would emanate through the light path 142 that ultimately reaches the surface 118 of the sensor chip 116. The filter gear 136 can include multiple filters as well as an opening, such as opening 138, or other filters 140, for exposing the camera assembly 100 to different frequencies of light, including the complete absence of light for detecting hot pixels. Hot pixels are pixels that operate contrary to normal pixels, where light appears to be sensed where no light occurs. This is well known to those skilled in the art. The focal adjustment gear 134 may be operated by an electronic motor 135 and is controlled by electronic step controller 142. Also, the filter gear maybe rotated by an electronic filter motor 144 that is controlled by the electronic controller 146. In such a configuration, the system may be set to automatically adjust the lens assembly 104 and also change the filters of the filter gear 136 in an automated manner. This is discussed in more detail below.

In the above embodiment, the focus of the camera assemblies is automatically done. In conventional processes, as discussed above, the focus of camera assembly is done manually and crudely, without the aid of any measurement of indicia, such as described above according to the invention. Some adjustment systems may exist, but they are very complicated and expensive, and they are not easily adaptable to a production process without great expense. According to the invention, the adjustment and measurement system described above can be done automatically using a controller. The improvement is derived from removing the operator judgment from the decision of quality of focus, providing improved distribution of the focused devices and improved throughput compared to manual focusing. This invention allows to determine focu quality based upon an objective criterion i.e. MTF that is precisely measured. In method used today the human judgement is the criterion for “goodness” of focus. Utilizing a system according to the invention, camera assembly focusing can be substantially improved in precision and distribution. Thus, such a system that embodies the invention could provide substantial improvement precision of the focus, distribution of the focus settings and throughput.

The invention utilizes a mechanical apparatus to rotate the lens in the lens holder while focus parameters are being measured. Utilizing a feedback loop and a search algorithm the lens is focused to a tight distribution of focus parameters. In addition this tool allows for testing of particles on the lens, IR glass and die with no mechanical movement of a light source. This apparatus allows for improvement in the quality of the camera assemblies manufactured. It also reduces the cost of manufacturing by increasing the throughput of the factory, reducing rework of poorly focused assemblies and reducing the need for additional testing after the assembly is completed.

Referring to FIG. 14, an automated system configured according to the invention is illustrated. The system is similar to that shown in FIG. 5, but now includes a CPU 156 configured to automatically measure and calculate the focus of the camera assembly by measuring focus of the focal indicia X₁, X₂, X₃, X₄ and X₅ located on the die surface 116. The motor 135 is used to adjust the focal position of the lens assembly 104 as described above. This motor is controlled by step control motor 142, which receives control signals from CPU 156. Similarly, motor 144 controls the filter gear 136 via step motor control 146 to choose the filter through which the camera assembly will be exposed to a light source 154, specifically exposing the lens assembly 104 and camera die 116 on its surface 118, illustrated with the focal indicia X₁, X₂, X₃, X₄ .and X₅. In one embodiment, each of the motor controls 142, 146 and the light source 154 is controlled by the CPU 156, so that adjustments can be made to the system to effect the testing process described above and illustrated in FIG. 10. The CPU may be connected to a storage device, such as memory 160, which may be a RAM, DRAM or other type of memory device. The memory may also exist on-chip with the CPU components. The memory 160 may include control system software 162 configured to store information related to CPU functions such as performing calculations, storing algorithms, or other software that, when executed by the CPU, causes the system to perform the novel method of testing and measuring as discussed above. The control system software may include adjustment control code in assembly 164 configured to enable the CPU to adjust the different components of the system, such as the motors 142, 146 and other components. The software may further include a focus computing module configured to enable the CPU to compute focus data, such as focus data related to the focal points X₁, X₂, X₃, X₄, .and X₅ located on the surface of the sensor chip. The focus module may include algorithm software 168 to enable the CPU to perform the different algorithms of the system, such as those discussed above and illustrated in FIG. 10. The software may further include measuring module 170 having software that enables the CPU to perform measuring calculations, such as measuring the focus value of the camera assembly using measured focus data. The Measuring module may further include a focus parameter look-up table (LUT) for retrieving pre-measured focus parameters to be used in the measurement process. The LUT is used to speed up the process of minimizing the number of eterations to reach the best focus position.

Also, the invention may include a means for gluing the lens assembly 104 in place after testing and measurements are made. A final adjustment can be made by CPU 156, then a glue reserve can have glue or other substance delivered to the camera assembly to set the optical lens assembly in place. The blue reserve may include a glue deposit spout 176, and may be controlled by glue control 178. The glue control may be controlled by CPU 156, which can be configured to execute code. In another embodiment, a laser can be used to fuse the lense holder and the lens assembly at the end of the focus process.

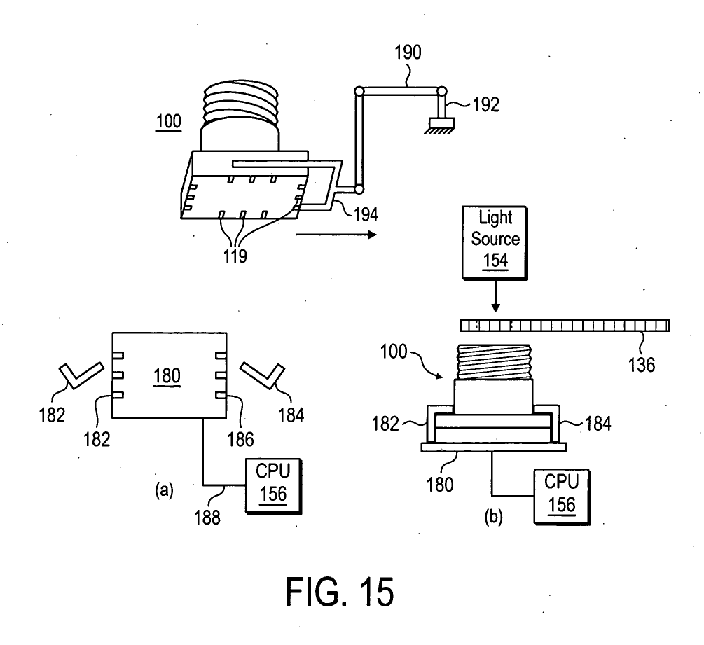

Those skilled in the art will understand the simple adaptability of this system to any automated production system. For example, referring to FIG. 15(a), the camera assembly 100 having electrical connections 119, such as a BGA or other type of contact, can be placed onto a testing mount 180 that has electrical contacts 186 corresponding to the camera assembly's electrical connections 119. The testing mount could also have clamps 182, 184, for example, to hold the camera assembly in place, and a connection 188 for communicating with CPU 156 and the rest of the system illustrated in FIG. 10. Once mounted in the assembly, referring to FIG. 15(b), the clamps 182, 184 can hold the camera assembly in place so that the light source 154 can transmit light through the lenses, as described above, so that the focus of the sensor die can be tested and measured.

Given this system, the camera assembly can be fed into a testing mount of such a system by a robotic or other automation means, electronic contacts can be made to the camera assembly, and the system can test and measure a series of camera assemblies for camera focus. For example, in FIG. 15c, a robotic arm 190 may be connected at one end to a robotic base 192 that controls the movements of the arm and to another end to a robotic clamp 194 that can grasp the camera assembly and place it in position for testing, such as on testing mount 180, and then clamped in with clamps 182, 184. Those skilled in the art will understand that there are many ways to adapt the novel testing and measurement system to automated processes. The invention, however, is not limited to any particular type of means of placing a camera assembly in a particular mount.

The invention has been described above as a system and method for testing measuring a miniature camera assembly, including testing, measuring and automatically setting the focus of the lens with respect to the die. It will be apparent to those skilled in the art, however, that the spirit and scope of the invention extends to other areas where accurate testing and measurement of small devices are useful, and the scope of the invention is defined by the appended claims and their equivalents.

1. A method for automatically setting the focus of a camera assembly; comprising:
providing a camera assembly having a sensor die having indicia points located on a surface, a lens assembly having at least one optical lens; a lens assembly holder configured to adjustably hold the lens assembly in a position about the sensor die, and;
exposing the lens assembly to a light source;
automatically adjusting the lens assembly with respect to the sensor die;
automatically measuring the focus of each focal indicia with respect to the positions of the lens assembly; and
setting the position of the lens assembly with respect to the sensor die at an optimal position.

2. A method according to claim 1, further comprising changing the position of the lens assembly when measuring all focal indicia and storing measurement information.

3. A method according to claim 2, further comprising retrieving and recording focus measurement data.

4. A method according to claim 1, further comprising
automatically changing the position of the lens assembly when measuring all focal indicia based on the focus measurement of all indicia.
retrieving focus measurement data from measurements taken at a plurality of positions of the lens assembly.

5. A method according to claim 1, wherein the provided camera assembly includes a sensor die configured with a plurality of focal indicia located in predetermined locations on a die surface facing the lens assembly and an adjustable lens assembly that is configured to be adjusted in a manner to vary the focal position between the lens assembly and the sensor die; the method further comprising:
changing the position of the lens assembly when measuring all focal indicia;
retrieving focus measurement data from measurements taken at a plurality of positions of the lens assembly.

6. A method according to claim 1, wherein the provided camera assembly includes a sensor die configured with a plurality of focal indicia located in at least three predetermined locations on a die surface facing the lens assembly and an adjustable lens assembly that is configured to be adjusted in a manner to vary the focal between the lens assembly and the sensor die; the method further comprising:
changing the position of the lens assembly when measuring all focal indicia;
retrieving focus measurement data from measurements taken at a plurality of positions of the lens assembly.

7. A method according to claim 6, wherein one focal indicia is located in the center of the die, and four focal indicia are located at four equidistant locations on the surface of the sensor die.

8. A method according to claim 7, further comprising changing the position of the lens and precise movement of the lens while measuring the focal indicia.

9. A method according to claim 8, wherein the focal points are measured according to a measurement transfer function (MTF).

10. A method according to claim 9, wherein the focal points are measured according to a MTF, wherein the focus of each point is measured while the lens assembly is located in a plurality of positions.

11. A method according to claim 9, wherein the focal points are measured according to a MTF, wherein the focus of each point is measured while the lens assembly is moved in a plurality of predetermined positions with respect to the sensor die surface.

12. A method according to claim 9, wherein the focal points are measured according to a MTF, wherein the focus of each point is measured while the lens assembly is moved within a range of positions with respect to the sensor die surface, and wherein focus measurements and respective lens locations are recorded.

13. A method according to claim 9, wherein the lens assembly includes a plurality of lenses of substantially coincident focal range, wherein the focal points are measured according to a MTF, wherein the focus of each point is measured while the lens assembly is moved within a range of positions with respect to the sensor die surface, and wherein focus measurements and respective lens locations are recorded.
